(19) United States
(12) Patent Application Publication
(10) Pub. No.: US 2015/0284895 A1
(43) Pub. Date: Oct. 8, 2015

(54) IMPULSE USED TO DETECT PERIODIC SPEED VARIATION CAUSED BY UNBALANCED LOADS IN WASHING MACHINE

(71) Applicant: General Electric Company, Schenectady, NY (US)

(72) Inventors: Paul Owen Davis, Prospect, KY (US); Martin Ortega Brena, Louisville, KY (US)

(73) Assignee: General Electric Company, Schenectady, NY (US)

(21) Appl. No.: 14/246,207

(22) Filed: Apr. 7, 2014

(51) Int. Cl. D06F 37/20; G01M 1/28; G01M 99/00; D06F 37/24; D06F 33/02

(52) U.S. Cl. CPC D06F 37/203; D06F 37/245; D06F 33/02; G01M 99/005; G01M 1/28; D06F 2202/065

(57) ABSTRACT

Washing machine appliances and associated methods for detecting periodic speed variation caused by an imbalanced load are provided. One example method for determining whether a load of a washing machine is imbalanced includes obtaining, by the washing machine, a sensor output signal describing a speed of a motor of the washing machine. The method includes determining, by the washing machine, a plurality of edge intervals. Each edge interval describes an interval of time between edges exhibited by the sensor output signal. The method includes determining, by the washing machine, a plurality of impulse values based on the plurality of edge intervals. The method includes determining, by the washing machine, whether the load of the washing machine is imbalanced based on the plurality of impulse values. One example washing machine includes one or more processors and a non-transitory computer-readable medium storing instructions for detecting periodic speed variation caused by an imbalanced load.

### FIELD OF THE INVENTION

The present disclosure relates generally to washing machine appliances. In particular, the present disclosure relates to using an impulse value for detecting periodic speed variation caused by an imbalanced load in a washing machine.

### BACKGROUND OF THE INVENTION

Washing machine appliances generally include a drum rotatably mounted within a tub of a cabinet. The drum defines a wash chamber for receiving articles for washing. During operation of washing machine appliances, wash fluid is directed into the tub and onto articles within the wash chamber of the drum. The motor can rotate the drum at various speeds to agitate articles within the wash chamber in wash fluid, to wring wash fluid from articles within the wash chamber, etc.

In particular, after the articles of clothing have been washed, the washing machine can drain the wash fluid and then spin the drum at a high speed in order to relieve the articles of clothing of remaining moisture and fluid. This process is generally known as a spin cycle or a spin out process.

In certain circumstances, prior to a spin cycle, the load in the washing machine can become imbalanced. In particular, the articles of clothing can become disproportionately distributed towards a single location and form an out of balance mass. For example, the articles of clothing can adhere together at a single location.

Such load imbalance can cause a number of problems if it remains uncorrected and present during the spin cycle. In particular, the imbalance can alter the center of mass for the drum and load as a whole so that the center of mass is no longer aligned with a shaft center of the washing machine. Rotating the drum at high speeds, for example during a spin cycle, in such condition can cause undesirable vibration, noise, or other damage to system components, including damage caused by the drum becoming so far misaligned that is strikes the washing machine cabinet.

Therefore, systems and methods for identifying an imbalanced load in a washing machine appliance are desirable.

### BRIEF DESCRIPTION OF THE INVENTION

Additional aspects and advantages of the invention will be set forth in part in the following description, or may be apparent from the description, or may be learned through practice of the invention.

One aspect of the present disclosure is directed to a method of determining whether a load of a washing machine is imbalanced. The method includes obtaining, by the washing machine, a sensor output signal describing a speed of a motor of the washing machine. The method includes determining, by the washing machine, a plurality of edge intervals. Each edge interval describes an interval of time between edges exhibited by the sensor output signal. The method includes determining, by the washing machine, a plurality of impulse values based on the plurality of edge intervals. The method includes determining, by the washing machine, whether the load of the washing machine is imbalanced based on the plurality of impulse values.

Another aspect of the present disclosure is directed to a washing machine appliance. The washing machine appliance includes one or more processors. The washing machine appliance includes a non-transitory computer readable medium storing instructions that, when executed by the one or more processors, cause the one or more processors to perform operations. The operations include obtaining a sensor output signal describing a speed of a motor of the washing machine. The sensor output signal exhibits a plurality of pulses. Each pulse has a rising edge and a falling edge. The operations include determining a plurality of edge intervals. Each edge interval describes an interval of time between edges exhibited by the sensor output signal. The operations include determining a plurality of impulse values. Each of the plurality of impulse values is based on three of the plurality of edge intervals. The three edge intervals for each of the plurality of impulse values are respectively separated by an impulse factor. The operations include determining whether a load of the washing machine appliance is imbalanced based on the plurality of impulse values.

Another aspect of the present disclosure is directed to a washing machine appliance. The washing machine appliance includes a cabinet. The washing machine appliance includes a tub positioned within the cabinet. The washing machine appliance includes a drum rotatably mounted within the tub. The drum defines a wash chamber for receipt of articles for washing. The washing machine appliance includes a motor in mechanical communication with the drum. The motor is configured for selectively rotating the drum within the tub. The washing machine appliance includes one or more processors. The washing machine appliance includes a non-transitory computer readable medium storing instructions that, when executed by the one or more processors, cause the one or more processors to perform operations. The operations include determining a plurality of edge intervals. Each edge interval describes an interval of time between edges exhibited by the sensor output signal. The sensor output signal describes the speed of the motor. The operations include calculating a plurality of impulse values based on the plurality of edge intervals. The operations include determining whether the drum is imbalanced based at least in part on the plurality of impulse values. Each of the plurality of impulse values comprises the absolute value of a first edge interval plus a third edge interval minus two times a second edge interval. For each of the plurality of impulse values, the second edge interval is temporally separated from the first edge interval by an impulse factor. For each of the plurality of impulse values, the third edge interval is temporally separated from the second edge interval by the impulse factor.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a front, elevation view of a washing machine appliance according to an example embodiment of the present disclosure;

FIG. 2 depicts a side, section view of the example washing machine appliance of FIG. 1;

FIG. 3 depicts a flow chart of an example method for determining whether a load of a washing machine is imbalanced according to an example embodiment of the present disclosure;

FIG. 4 depicts a graphical representation of an example sensor output signal according to an example embodiment of the present disclosure;

FIG. 5 depicts example edge intervals according to an example embodiment of the present disclosure;

FIG. 6 depicts an example graphical representation of average impulse values according to an example embodiment of the present disclosure;

FIGS. 7A-7C depict example graphical representations of motor speed signals according to example embodiments of the present disclosure;

FIG. 8 depicts an example graphical representation of an impulse value calculation according to an example embodiment of the present disclosure;

FIG. 9 depicts an example graphical representation of an impulse factor calculation according to an example embodiment of the present disclosure;

FIG. 10 depicts an example graphical representation of impulse value calculations according to an example embodiment of the present disclosure;

FIG. 11 depicts an example graphical representation of impulse value calculations according to an example embodiment of the present disclosure;

FIG. 12 depicts an example graphical representation of imbalanced measurement calculations according to an example embodiment of the present disclosure;

FIG. 13 depicts an example graphical representation of impulse values according to an example embodiment of the present disclosure; and

FIG. 14 depicts an example graphical representation of average impulse values according to an example embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

Generally, the present disclosure is directed to washing machine appliances and methods of operation that use calculations of impulse values to detect the presence of a periodic variation in the speed of the motor that is characteristic of an imbalanced load. In particular, impulse values are calculated in a fashion that is sensitive to the fundamental frequency of a speed variation associated with imbalanced loads and can used to determine whether the load of the washing machine appliance is imbalanced.

More particularly, as discussed above, when the load of a washing machine becomes imbalanced, rotation of the drum at high speeds can cause undesirable vibration. This effect results from the imbalanced load distorting the forces required to rotate the drum such that the forces are not consistent throughout the rotational cycle.

Likewise, imbalanced loads can result in a periodic variation being exhibited by the speed of the motor. In particular, the speed of the motor will increase and decrease periodically due to the imbalanced forces caused by the imbalanced load. For example, in a vertical axis washing machine, the speed of the motor may change at a uniform periodic rate as an out of balance load, balancing ring mass and other rotating parts dynamically interact with the non-rotating masses and the wash tub suspension.

Therefore, analyzing a signal provided by a sensor that measures the speed of the motor to identify the presence of a periodic variation that is characteristic of imbalanced loads is one technique to identify the presence of an imbalanced load. Thus, the present disclosure provides washing machine appliances and methods of operation that use an impulse value to detect the presence of such a variation.

In mechanical physics, impulse is the application of force for a specific time period. On the other hand, impulse can be the magnitude of change between two points in time in discrete (e.g. digital) data that is sampled at a fixed rate. In particular, in some scenarios, impulse can be defined by the equation: I=|x₀−(2*x₁)+x₂|, where I is impulse and x is the value of the signal being considered.

In some embodiments of the present disclosure, the impulse can be proportional to the difference between the middle value and average of the first and last value. In such implementations, a simple calculation can be used to produce a value of impulse that may have a sufficient correlation with the actual values of the variation in speed or the actual values of the derivatives of speed such as acceleration to be useful for detecting imbalanced wash loads.

According to an aspect of the present disclosure, impulse values can be determined by, first, obtaining a sensor output signal that describes the speed of the motor. For example, the sensor output signal can be a signal output by a single Hall effect sensor. The sensor output signal can contain a plurality of pulses, with each pulse having a rising edge and a falling edge.

A plurality of edge intervals can be determined based on the sensor output signal. In particular, each edge interval can describe an amount of time between edges exhibited by the sensor output signal.

As an example, in the instance that the sensor output signal is output by a single Hall effect sensor, each edge interval can describe the amount of time between consecutive rising edges or consecutive rising and falling edges. Thus, in such instances, the magnitude of the determined edge intervals can have an inverse relationship to the speed of the motor.

According to another aspect of the present disclosure, a plurality of impulse values can be determined based on the plurality of edge intervals. In some embodiments, each impulse value can be calculated based on three edge intervals. For example, each impulse value can be calculated according to the following equation: I=|dtₙ₁−(2*dtₙ₂)+dtₙ₃|, where dt corresponds to an edge interval and n is the position in a sequence of values of dt. Thus, an impulse value of greater magnitude can indicate that the sensor output signal is experiencing a greater range of variation between the edge intervals used to calculate the impulse value.

According to yet another aspect of the present disclosure, the three edge intervals used to calculate each impulse value can be temporally spaced apart by a fixed number of interval values known as an impulse factor. More particularly, each impulse value can be calculated according to the following equation: I=|dtₙ−(2*dt_{n+Dk})+dt_{n+2Dk}|, where Dk is the impulse factor.

In some embodiments, the impulse factor can be based at least in part on a frequency associated with the speed variation exhibited by the motor speed signal of the washing machine when the load of the washing machine is imbalanced. Thus, according to the present disclosure, the value of the impulse factor can be selected so as to make the resultant value of impulse sensitive to the speed with a fundamental rate of variation to be detected.

In particular, in some embodiments, the impulse factor can be approximately equivalent to an amount of time equal to integral fractions such as one-half or three-halves of a period of the frequency associated with the speed variation to be detected. In such fashion, the resultant impulse value can be sensitive to the dynamic effects of an imbalance that cause a speed signal to be modulated at some particular rate.

In some embodiments, the impulse factor can be calculated in real time for each impulse value or for each batch of impulse values. For example, in some embodiments, the impulse factor can be calculated according to the following equation: Dₖ=Kₜ/t_{edge-edge}, where Kₜ is a constant and t_{edge-edge} is a moving average of recent edge intervals. Thus, the impulse factor can be calculated based on the current average speed of the motor, as reflected by the most recent edge intervals. The constant Kₜ can be machine and/or operation-specific and can account for different periodic variation characteristics exhibited by different washing machine appliances when performing different operations with an imbalanced load. The constant Kₜ can also account for the effect of the speed ratio between the basket and motor and the number of sensor edges per revolution of the motor.

According to another aspect of the present disclosure, the calculated impulse values can be analyzed to determine whether the load of the washing machine is imbalanced. As an example, in some embodiments, if a certain number (e.g. one or more) of the impulse values are greater than a threshold value, then it can be assumed that the load of the washing machine is imbalanced. Thus, because higher impulse values are indicative of a speed signal containing a periodic variation characteristic known to occur with an imbalanced load, then it can be assumed that the load is imbalanced when the calculated impulse values exceed a threshold value.

As another example, in some embodiments, a moving average of impulse values can be calculated. If a certain number of samples of the moving average of impulse values exceed the threshold value, then it can be assumed that the load of the washing machine is imbalanced. The length of the moving average can be tuned to improve the sensitivity or selectivity of the resultant values of impulse value to imbalance.

Thus, the present disclosure provides a mathematically efficient digital impulse calculation tuned to be sensitive to detecting the modulation of speed of a washing machine drive motor with a specific modulation frequency and to discriminate between different amounts of imbalance. The response of the impulse value can be tuned to the particular periodic speed variation to be detected by determining an appropriate impulse factor to result in a number of edge intervals to ignore between the edge intervals used to calculate each of a plurality of impulse values. A moving average of the impulse values can be compared to a threshold value to assist in determining whether the imbalance of the load of the washing machine exceeds a threshold.

### Example Washing Machine

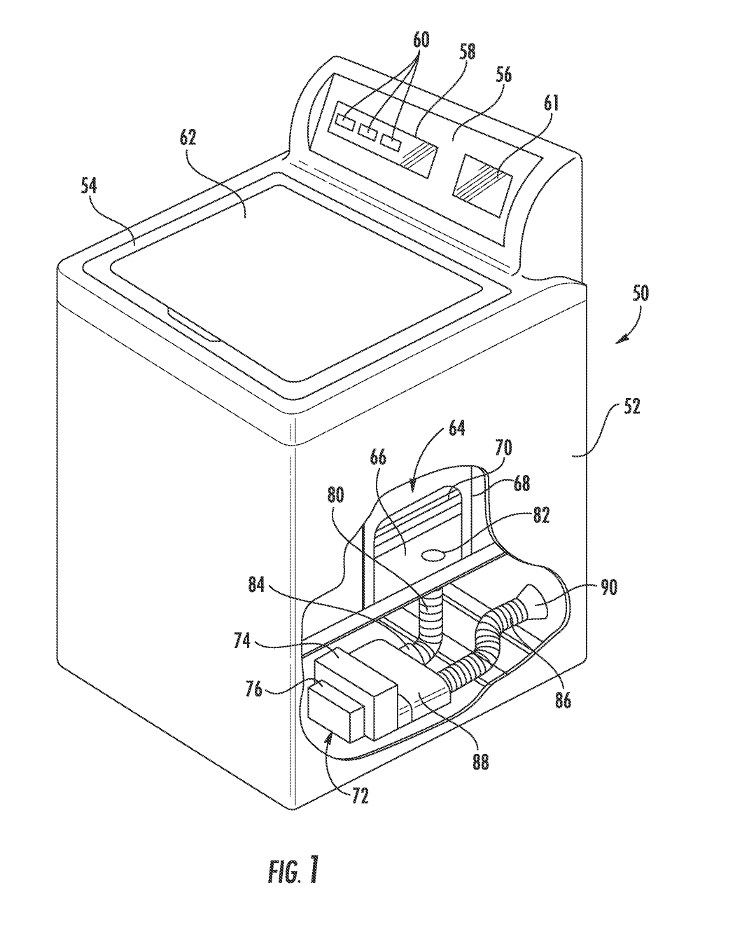

FIG. 1 is a perspective view partially broken away of an exemplary washing machine 50 including a cabinet 52 and a cover 54. A backsplash 56 extends from cover 54, and a control panel 58 including a plurality of input selectors 60 is coupled to backsplash 56. Control panel 58 and input selectors 60 collectively form a user interface input for operator selection of machine cycles and features, and in one embodiment a display 61 indicates selected features, a countdown timer, and other items of interest to machine users. A lid 62 is mounted to cover 54 and is rotatable about a hinge (not shown) between an open position (not shown) facilitating access to a wash tub 64 located within cabinet 52, and a closed position (shown in FIG. 1) forming a sealed enclosure over wash tub 64.

As illustrated in FIG. 1, washing machine 50 is a vertical axis washing machine. While the present disclosure is discussed with reference to a vertical axis washing machine, those of ordinary skill in the art, using the disclosures provided herein, should understand that the subject matter of the present disclosure is equally applicable to other washing machines, such as horizontal axis washing machines.

Tub 64 includes a bottom wall 66 and a sidewall 68, and a basket 70 is rotatably mounted within wash tub 64. A pump assembly 72 is located beneath tub 64 and basket 70 for gravity assisted flow when draining tub 64. Pump assembly 72 includes a pump 74 and a motor 76. A pump inlet hose 80 extends from a wash tub outlet 82 in tub bottom wall 66 to a pump inlet 84, and a pump outlet hose 86 extends from a pump outlet 88 to an appliance washing machine water outlet 90 and ultimately to a building plumbing system discharge line (not shown) in flow communication with outlet 90.

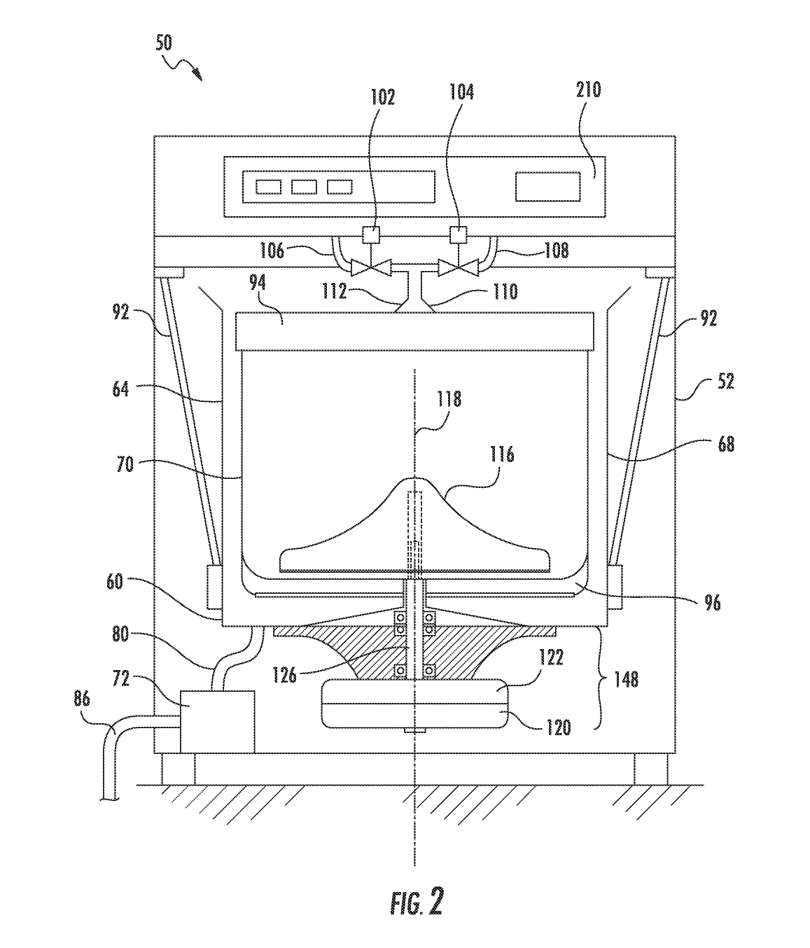

FIG. 2 is a front elevational schematic view of washing machine 50 including wash basket 70 movably disposed and rotatably mounted in wash tub 64 in a spaced apart relationship from tub side wall 68 and tub bottom (not shown). Basket 70 includes a plurality of perforations therein to facilitate fluid communication between an interior of basket 70 and wash tub 64.

A hot liquid valve 102 and a cold liquid valve 104 deliver fluid, such as water, to basket 70 and wash tub 64 through a respective hot liquid hose 106 and a cold liquid hose 108. Liquid valves 102, 104 and liquid hoses 106, 108 together form a liquid supply connection for washing machine 50 and, when connected to a building plumbing system (not shown), provide a fresh water supply for use in washing machine 50. Liquid valves 102, 104 and liquid hoses 106, 108 are connected to a basket inlet tube 110, and fluid is dispersed from inlet tube 110 through a known nozzle assembly 112 having a number of openings therein to direct washing liquid into basket 70 at a given trajectory and velocity. A known dispenser (not shown in FIG. 2), may also be provided to produce a wash solution by mixing fresh water with a known detergent or other composition for cleansing of articles in basket 70.

A known agitation element 116, such as a vane agitator, impeller, auger, or oscillatory basket mechanism, or some combination thereof is disposed in basket 70 to impart an oscillatory motion to articles and liquid in basket 70. In different embodiments, agitation element 116 may be a single action element (i.e., oscillatory only), double action (oscillatory movement at one end, single direction rotation at the other end) or triple action (oscillatory movement plus single direction rotation at one end, singe direction rotation at the other end). As illustrated in FIG. 2, agitation element 116 is oriented to rotate about a vertical axis 118.

Basket 70 and agitator 116 are driven by a motor 120 through a transmission and clutch system 122. In an exemplary embodiment, motor 120 is a polyphase variable speed motor. The motor 120 drives output shaft 126 to rotate basket 70 within wash tub 64. Clutch system 122 facilitates driving engagement of basket 70 and agitation element 116 for rotatable movement within wash tub 64, and clutch system 122 facilitates relative rotation of basket 70 and agitation element 116 for selected portions of wash cycles. Motor 120 and transmission and clutch system 122 collectively are referred herein as a machine drive system 148.

Basket 70, tub 64, and machine drive system 148 are supported by a vibration dampening suspension system 92. The damping system 92 can include a plurality of damping elements, such as piston-cylinder damping elements, coupled to the wash tub 64. The suspension system 92 can include other elements, such as a balance ring 94 disposed around the upper circumferential surface of the wash basket 70. The balance ring 94 can be used to counterbalance any out of balance condition for the wash machine as the basket 70 rotates within the wash tub 64. The wash basket 70 could also include a balance ring 96 located at a lower circumferential surface of the wash basket 70.

Suspension system 92 operates to dampen dynamic forces as the wash basket 70 rotates within the wash basket 64. The suspension system 92 has various natural operating frequencies of the dynamic system. These natural operating frequencies are referred to as the modes of suspension for the washing machine. For instance, the first mode of suspension for the washing machine occurs when the dynamic system including the wash basket 70, tub 64, and suspension system 92 are operating at the first resonant or natural frequency of the dynamic system. The second mode of suspension for the washing machine occurs when the dynamic system including the wash basket 70, tub, 74, and suspension system 92 are operating at the second resonant or natural frequency of the dynamic system.

Operation of machine 50 is controlled by a controller 210 which is operatively coupled to the user interface input located on washing machine backsplash 56 (shown in FIG. 1) for user manipulation to select washing machine cycles and features. In response to user manipulation of the user interface input, controller 210 operates the various components of machine 50 to execute selected machine cycles and features.

Controller 210 may include one or more processors and a memory. The memory may be a separate component from the processor(s) or may be included onboard within the processor(s).

The processor(s) can be any suitable processing device, such as a microprocessor, microcontroller, integrated circuit, or other suitable processing device. The memory can include any suitable computing system or media, including, but not limited to, non-transitory computer-readable media, RAM, ROM, hard drives, flash drives, or other memory devices. The memory can store information accessible by processor(s), including instructions that can be executed by processor(s). The instructions can be any set of instructions that when executed by the processor(s), cause the processor(s) to provide desired functionality.

Controller 210 or other processing components of machine 50 can determine a current speed of motor 120 according to any known techniques. For example, a speed signal describing the current speed of the motor can be created and provided to controller 210 according to back electromotive force techniques or based on the output of one or more sensors or other components including, for example, an optical sensor or magnetic-based sensors such as Hall effect sensors.

As an example, in some implementations, machine 50 can include a single Hall effect sensor (not shown) that outputs a sensor output signal. The Hall effect sensor can be positioned at any suitable location where it is able to capture data describing the current speed of the motor. For example, the Hall effect sensor can be mounted at various locations on motor 120. One of skill in the art, in light of the disclosures provided herein, will be familiar with the principles of operation of a Hall effect sensor.

In an illustrative embodiment, laundry items are loaded into basket 70, and washing operation is initiated through operator manipulation of control input selectors 60 (shown in FIG. 1). Tub 64 is filled with water and mixed with detergent to form a wash fluid, and basket 70 is agitated with agitation element 116 for cleansing of laundry items in basket 70. That is, agitation element is moved back and forth in an oscillatory back and forth motion. In the illustrated embodiment, agitation element 116 is rotated clockwise a specified amount about the vertical axis of the machine, and then rotated counterclockwise by a specified amount. The clockwise/counterclockwise reciprocating motion is sometimes referred to as a stroke, and the agitation phase of the wash cycle constitutes a number of strokes in sequence. Acceleration and deceleration of agitation element 116 during the strokes imparts mechanical energy to articles in basket 70 for cleansing action. The strokes may be obtained in different embodiments with a reversing motor, a reversible clutch, or other known reciprocating mechanism.

After the agitation phase of the wash cycle is completed, tub 64 is drained with pump assembly 72. Laundry items are then rinsed and portions of the cycle repeated, including the agitation phase, depending on the particulars of the wash cycle selected by a user.

While described in the context of a specific embodiment of vertical axis washing machine 50, it will be understood that vertical axis washing machine 50 is provided by way of example only. Other washing machine appliances having different configurations, different appearances, and/or different features may also be utilized with the present subject matter as well, including, for example, horizontal axis washing machine appliances.

Thus, the discussion provided with respect to FIGS. 1 and 2 and example washing machine 50 are provided for the purposes of example and explanation only. Therefore, the teachings of the present disclosure are not limited to use with washing machine 50, but can be broadly applied to any washing machine appliance.

### Example Methods

FIG. 3 depicts a flow chart of an example method (300) for determining whether a load of a washing machine is imbalanced according to an example embodiment of the present disclosure. Method (300) can be performed by any suitable washing machine appliance.

In addition, FIG. 3 depicts steps performed in a particular order for purposes of illustration and discussion. Those of ordinary skill in the art, using the disclosures provided herein, will understand that the various steps of method (300) can be omitted, adapted, and/or rearranged in various ways without departing from the scope of the present disclosure.

At (302) a sensor output signal can be obtained. The sensor output signal can describe a speed of a motor of the washing machine. In some implementations, the sensor output signal can be obtained at (302) from a Hall effect sensor positioned on the motor, a shaft of the motor, or some other location.

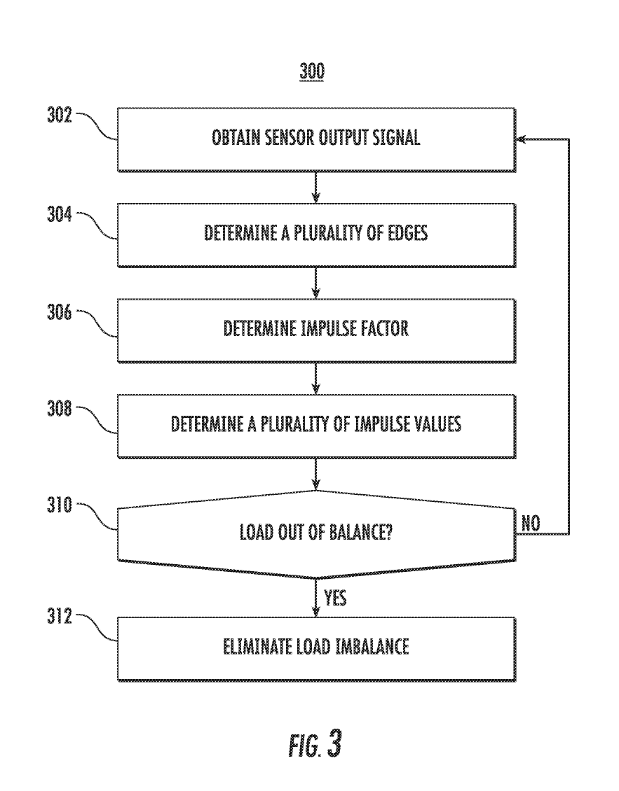

As an example, FIG. 4 depicts a graphical representation of an example sensor output signal 402 according to an example embodiment of the present disclosure. For example, sensor output signal 402 can be output by a Hall effect sensor and can describe motor speed of a washing machine appliance.

Sensor output signal 402 can have a plurality of pulses (e.g. pulses 410 and 420). Each pulse can be defined by a rising edge and a falling edge. For example, pulse 410 can be defined by a rising edge 412 and a falling edge 414. Likewise, pulse 420 can be defined by a rising edge 422 and a falling edge 424. As noted in FIG. 4, rising edges can correspond to the first signal value greater than zero (or a small threshold value) while falling edges can correspond to the last signal value greater than zero (or the small threshold value).

Referring again to FIG. 3, at (304) a plurality of edge intervals can be determined. Each edge interval can describe an interval of time between edges exhibited by the sensor output signal obtained at (302).

As an example, referring again to FIG. 4, a first edge interval, dtₙ₌₁, can describe the interval of time between edge 412 and edge 414; a second edge interval, dtₙ₌₂, can describe the interval of time between edge 414 and edge 422; and a third edge interval, dtₙ₌₃, can describe the interval of time between edge 422 and edge 424.

As another example, FIG. 5 depicts example edge intervals according to an example embodiment of the present disclosure. For example, 502 shows an edge interval between consecutive rising and falling edges and an edge interval between consecutive falling and rising edges. As other examples, 504 shows an edge interval between consecutive rising edges and an edge interval between consecutive falling edges. It will be appreciated that edge intervals can be determined according to any of the different combinations shown or discussed herein, including, for example, edge intervals describing only intervals between consecutive rising and falling edges.

Referring again to FIG. 3, at (306) an impulse factor Dₖ can be determined. For example, the impulse factor can be an integral number of edge intervals that serve as a difference in time acquisition between edge intervals used to determine impulse values at (308). In some implementations, the impulse factor can be based on the time period of the fundamental frequency associated with a periodic speed variation exhibited by a motor speed signal of the washing machine when the load of the washing machine is imbalanced.

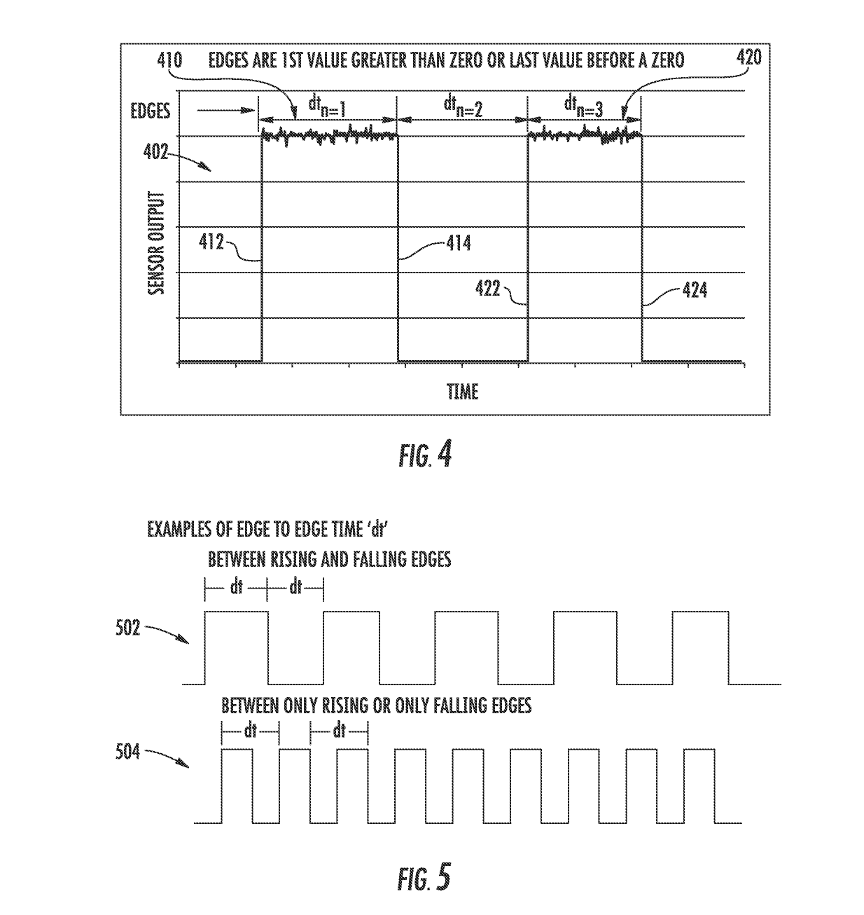

Thus, according to the present disclosure, the value of the impulse factor Dₖ can be determined at (306) so as to produce an impulse value that is sensitive to the periodic variation to be detected. As a further explanation of the above principle, reference will now be made to FIGS. 6-9.

FIG. 6 depicts an example graphical representation 600 of average impulse values according to an example embodiment of the present disclosure. The circle plots correspond to average impulse values calculated for a washing machine with a load that is significantly out of balance; the triangle plots correspond to average impulse values calculated for a washing machine with a load that is moderately out of balance; and the diamond plots correspond to average impulse values calculated for a washing machine with a load that is not out of balance.

In particular, the average impulse values plotted in graphical representation 600 are an average of impulse values that were respectively calculated using sequential, consecutive edge intervals. As can be seen from FIG. 6, the average impulse values for the three washing machines are only differentiable to a relatively small degree. This is because use of sequential, consecutive edge intervals to calculate impulse values does not specifically tune the impulse value to be sensitive to the periodic speed variation sought to be detected.

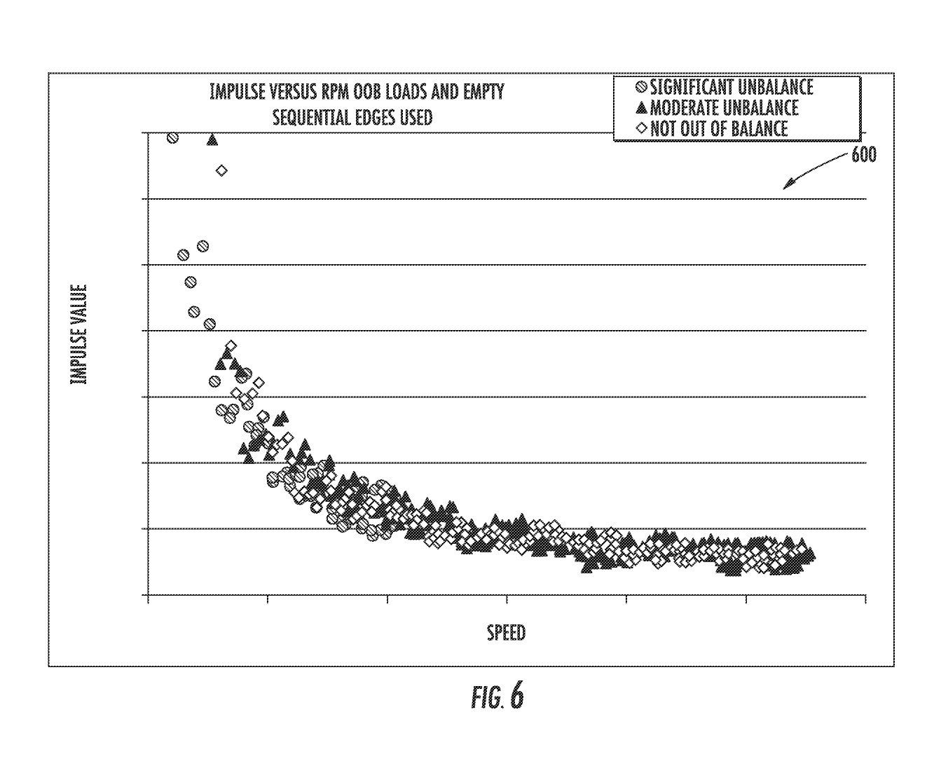

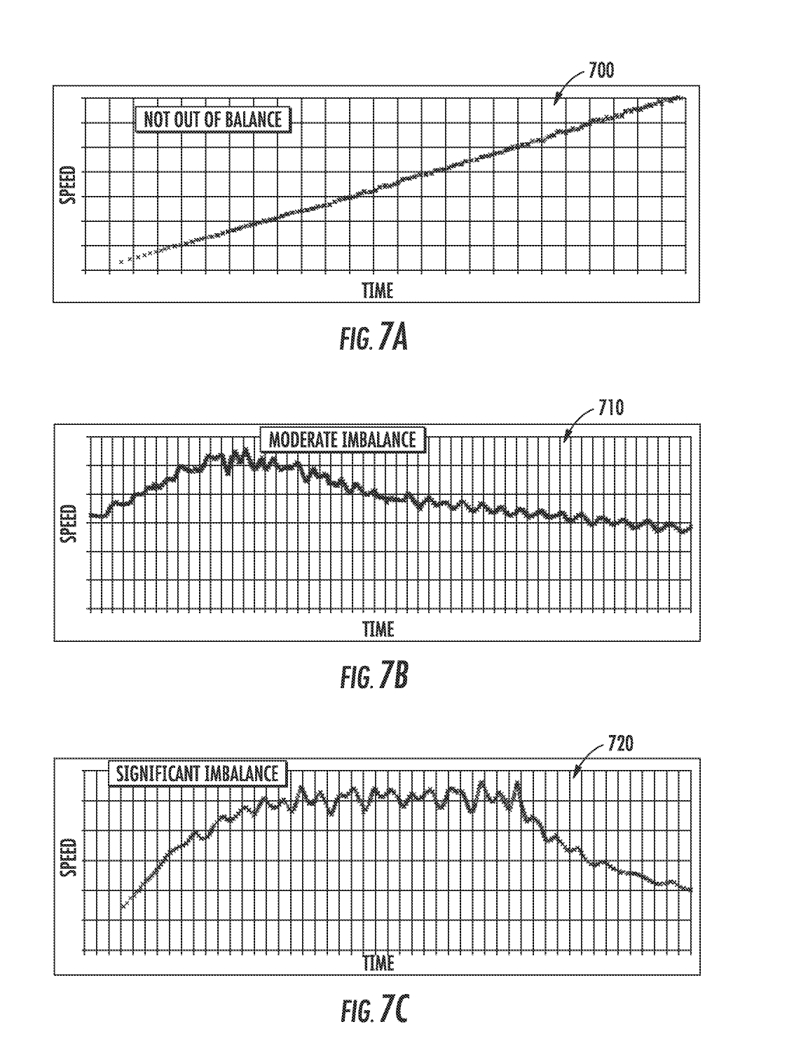

As an example, FIGS. 7A-7C depict example graphical representations of motor speed signals according to example embodiments of the present disclosure. In particular, graphical representation 700 of FIG. 7A depicts a motor speed signal of a washing machine with a load that is not out of balance; graphical representation 710 of FIG. 7B depicts a motor speed signal of a washing machine with a load that is moderately out of balance; and graphical representation 720 of FIG. 7C depicts a motor speed signal of a washing machine with a load that is significantly out of balance.

As can be seen from a comparison of FIGS. 7A-7C, the amplitude of the periodic speed variation exhibited by the motor speed signal of the washing machine is generally proportional to the degree of wash load imbalance. However, for such speed variation to be detected by the response of the impulse value, the time span used to calculate impulse must be tuned so that it is sensitive to the fundamental period of the variation.

As an example, FIG. 8 depicts an example graphical representation 800 of an impulse value calculation according to an example embodiment of the present disclosure. Graphical representation 800 shows the impact of using an impulse factor Dₖ to provide a difference in the time acquisition between edge intervals (dt). In particular, graphical representation 800 shows the impact of selecting an impulse factor Dₖ such that the first edge interval (dt₁) is spaced approximately one-half of the time period of the frequency of the modulation of speed from the second edge interval (dt_{1+Dk}). Likewise, the third edge interval (dt_{1+2Dk}) is spaced approximately one-half of this same time period from the second edge interval (dt_{1+Dk}).

As shown by FIG. 8, using an appropriately valued impulse factor to space the edge intervals used to calculate impulse results in the impulse value reflecting the periodic effects of imbalance on a speed signal. Otherwise, if the edge intervals are not spaced so as to be aligned with the period of the modulation of speed, the impulse values may fail to reflect such increased effect of imbalance on the dynamic motion of the washer, as shown by the average of the first and third edge intervals.

Referring again to FIG. 3, as an example, at (306) the impulse factor value can be predetermined, stored in a memory, and accessed at (306). For example, the impulse factor can be predetermined to approximately equal an amount of time equal to one-half a period of the frequency associated with the speed variation to be detected.

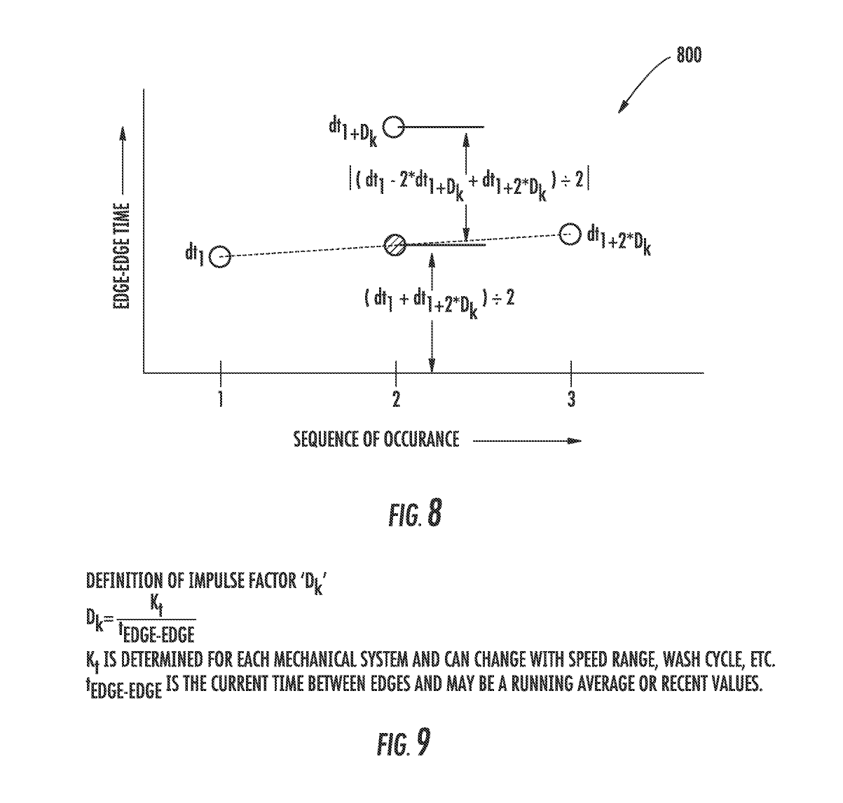

As another example, at (306) the impulse factor can be calculated in real time for each impulse value or for each batch of impulse values. For example, as shown in FIG. 9, the impulse factor can be calculated according to the following equation: Dₖ=Kₜ/t_{edge-edge}, where Kₜ is a constant and t_{edge-edge} is a moving average of recent edge intervals. Thus, the impulse factor can be calculated to include as a factor the current average speed of the motor, as reflected by the most recent edge intervals.

As noted in FIG. 9, the constant Kₜ can be machine and/or operation-specific and can account for different variation characteristics (e.g. frequency of imbalance modulation or motor speed ratio or sensor edges per motor revolution) exhibited by different washing machine appliances when performing different operations with an imbalanced load. Therefore, the constant Kₜ can be identified through testing a washing machine with different load imbalances and analyzing the resulting motor speed signals to identify the period of the speed modulation that is characteristic of a load imbalance.

Referring again to FIG. 3, at (308) a plurality of impulse values can be determined. As an example, at (308) each impulse value can be calculated according to the following equation: I=|dtₙ−(2*dt_{n+Dk})+dt_{n+2Dk}|, where Dₖ is the impulse factor determined at (306).

Furthermore, in some embodiments, steps (304)-(308) can be performed in an iterative or parallel manner so that the impulse factor used to calculated each impulse value at (308) is unique.

In some embodiments, each impulse value determined at (308) can be calculated based on three of the plurality of edge intervals that are sequential, but non-consecutive in nature. Further, each set of three edge intervals can follow a previous set of three edge intervals.

As an example, FIG. 10 depicts an example graphical representation of impulse value calculations according to an example embodiment of the present disclosure. In particular, as shown in FIG. 10, each impulse value I is calculated based on three of the plurality of edge intervals that are sequential, but non-consecutive in nature (e.g. temporally spaced by an impulse factor Dₖ).

Referring again to FIG. 3, as another example, in some embodiments, each impulse value determined at (308) can be calculated based on three of the plurality of edge intervals that are staggered with respect to edge intervals used to calculate other of the plurality of impulse values.

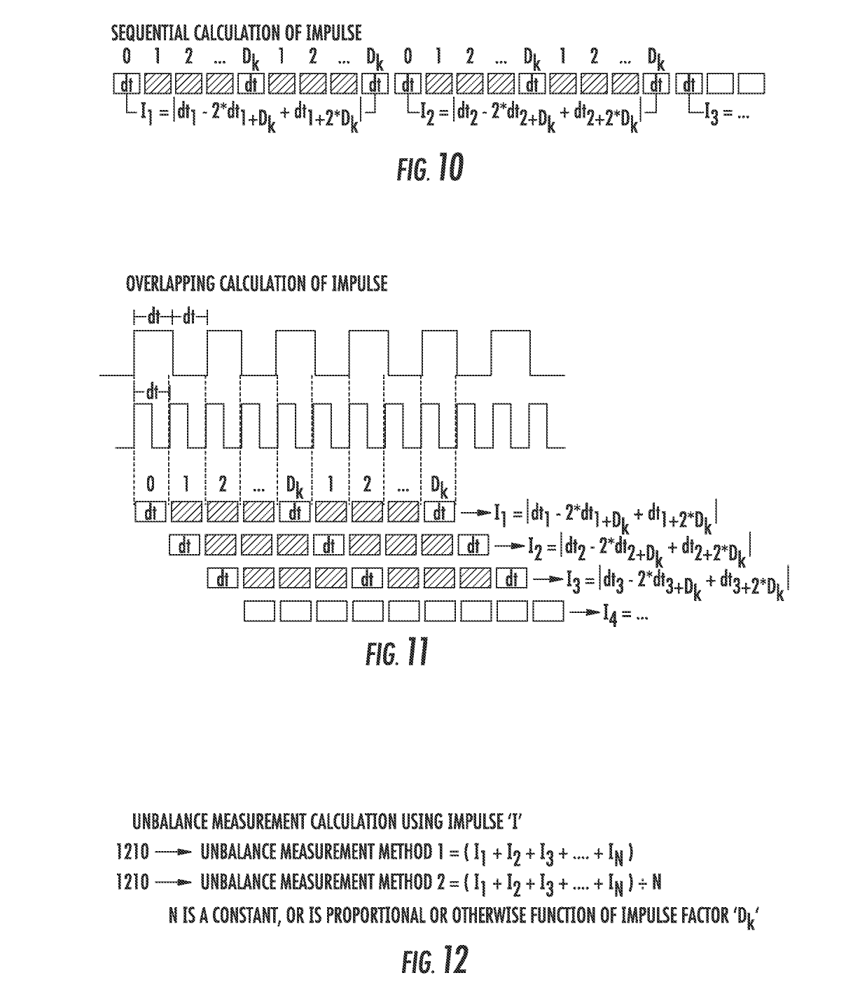

As an example, FIG. 11 depicts an example graphical representation of impulse value calculations according to an example embodiment of the present disclosure. As shown by FIG. 11, each impulse value I can be calculated based on edge intervals (dt) that are staggered with respect to edge intervals used to calculate other impulse values.

Referring again to FIG. 3, at (310) it can be determined whether the load is out of balance based on the plurality of impulse values determined at (308).

As an example, in some embodiments, if a certain number (e.g. one or more) of the impulse values determined at (308) are greater than a threshold value, then it can be assumed at (310) that the load of the washing machine is imbalanced.

Thus, because higher impulse values are indicative of a speed signal containing significant speed variation, then it can be assumed that the load is imbalanced when the calculated impulse values exceed a threshold value.

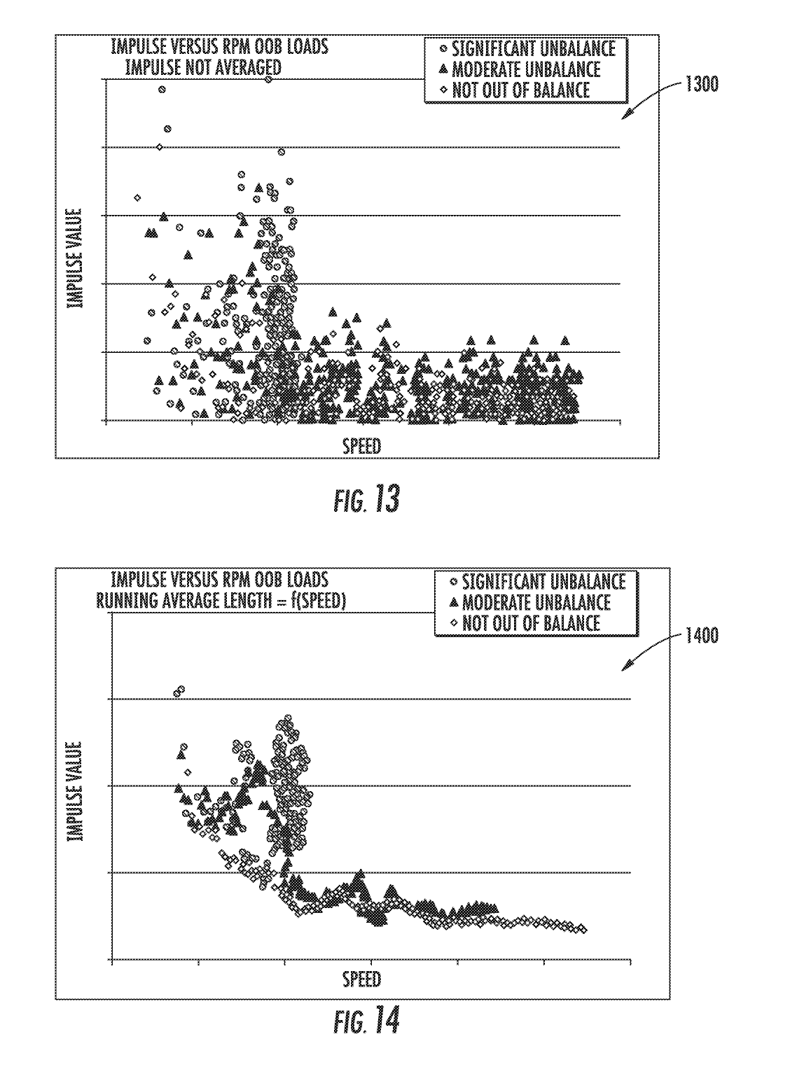

As an example, FIG. 13 depicts an example graphical representation 1300 of impulse values according to an example embodiment of the present disclosure. The circle plots correspond to impulse values calculated for a washing machine with a load that is significantly out of balance; the triangle plots correspond to impulse values calculated for a washing machine with a load that is moderately out of balance; and the diamond plots correspond to impulse values calculated for a washing machine with a load that is not out of balance.

In particular, the impulse values plotted in graphical representation 1300 have not been calculated as a running average. It can be seen from FIG. 13 that the impulse values associated with washing machines having imbalanced loads are differentiable from the impulse values associated with the washing machine having a load that is not out of balance.

Referring again to (310) of FIG. 3, as another example, if a sum of the impulse values determined at (308) are greater than a threshold value, then it can be assumed at (310) that the load of the washing machine is imbalanced.

As an example, FIG. 12 depicts an example graphical representation of imbalanced measurement calculations according to an example embodiment of the present disclosure. As shown at 1210 of FIG. 12, the plurality of impulse values can be summed. The sum can then be compared to a threshold value.

Referring again of FIG. 3, as another example, at (310) a moving average of impulse values can be calculated. If a certain number (e.g. one or more) of samples of the moving average of impulse values exceed the threshold value, then it can be assumed that the load of the washing machine is imbalanced.

As an example, referring again to FIG. 12, as shown at 1220 of FIG. 12, the plurality of impulse values can be averaged. The average can be a moving average or a cumulative average. If a moving average is used, the length of the moving average can be predetermined or adjusted. A plurality of samples of the moving average can be taken over a sampling period. In some implementations, the moving average can be represented by the summation of the running sequence of values without dividing the result by the length of the sequence, thereby eliminating a calculation step and reducing processing requirements.

As another example, As FIG. 14 depicts an example graphical representation 1400 of average impulse values according to an example embodiment of the present disclosure. The circle plots correspond to average impulse values calculated for a washing machine with a load that is significantly out of balance; the triangle plots correspond to average impulse values calculated for a washing machine with a load that is moderately out of balance; and the diamond plots correspond to average impulse values calculated for a washing machine with a load that is not out of balance.

As can be seen from graphical representation 1400, the impulse values associated with washing machines having imbalanced loads are clearly differentiable from the impulse values associated with the washing machine having a load that is not out of balance.

Referring again to FIG. 3, if it is determined at (310) that the load is not out of balance, then method (300) can return to (302) and continue to obtain additional readings from the sensor output signal. As another example, if the sampling period has ended without detecting an out of balance load, then the washing machine may proceed to perform scheduled operations, such as, for example, a spin cycle.

However, if it is determined at (310) that the load is out of balance, then method (300) can proceed to (312) and eliminate the load imbalance. For example, the washing machine may perform an audio or visual alarm to alert the user to the imbalanced load. As another example, the washing machine may perform other operations to eliminate the load imbalance, such as, in the instance of a horizontal axis washing machine, slowly rotating the drum so that the imbalanced load is redistributed.

Thus, the present disclosure provides washing machine appliances and methods of operation that use calculations of impulse values to detect the presence of a periodic variation in the speed of the motor that is characteristic of an imbalanced load. In particular, calculations of impulse values in a fashion that is sensitive to the frequency of a speed variation associated with imbalanced loads are used to determine whether the load of the washing machine appliance is imbalanced.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of determining whether a load of a washing machine is imbalanced, the method comprising:
obtaining, by the washing machine, a sensor output signal describing a speed of a motor of the washing machine;
determining, by the washing machine, a plurality of edge intervals, wherein each edge interval describes an interval of time between edges exhibited by the sensor output signal;
determining, by the washing machine, a plurality of impulse values based on the plurality of edge intervals; and
determining, by the washing machine, whether the load of the washing machine is imbalanced based on the plurality of impulse values.

2. The method of claim 1, wherein the sensor output signal is output by a Hall effect sensor.

3. The method of claim 1, wherein each edge interval describes an interval of time between consecutive rising edges or between consecutive falling edges of the sensor output signal.

4. The method of claim 1, wherein each edge interval describes an interval of time between consecutive rising and falling edges of the sensor output signal.

5. The method of claim 1, wherein determining, by the washing machine, the plurality of impulse values based on the plurality of edge intervals comprises respectively calculating each of the plurality of impulse values based on three of the plurality of edge intervals that are non-consecutive in nature.

6. The method of claim 5, wherein each of the plurality of impulse values is calculated based on three of the plurality of edge intervals that are staggered with respect to edge intervals used to calculate other of the plurality of impulse values.

7. The method of claim 1, wherein each of the plurality of impulse values satisfies an equation:
I=|dtₙ−(2*dt_{(n+Dk)})+dt_{(n+2Dk)}|;
wherein I comprises the impulse value;
wherein dt comprises an edge interval;
wherein n is a position of a first value of dt in a sequence; and
wherein Dk comprises an impulse factor.

8. The method of claim 7, wherein the impulse factor is based at least in part on a frequency associated with a modulation of speed exhibited by a motor speed signal of the washing machine when the load of the washing machine is imbalanced.

9. The method of claim 8, wherein the impulse factor comprises an amount of time approximately equal to one-half a period of the frequency associated with the modulation of speed exhibited by the motor speed signal of the washing machine when the load of the washing machine is imbalanced.

10. The method of claim 7, wherein the impulse factor Dₖ satisfies an equation:
Dₖ=Kₜ/t_{edge-edge};
wherein Kₜ comprises a constant; and
wherein t_{edge-edge} comprises a moving average of recent edge intervals.

11. The method of claim 1, wherein determining, by the washing machine, whether the load of the washing machine is imbalanced based on the plurality of impulse values comprises determining whether a moving average of the plurality of impulse values is greater than a threshold value.

12. A washing machine appliance, comprising:
one or more processors; and
a non-transitory computer readable medium storing instructions that, when executed by the one or more processors, cause the one or more processors to perform operations, the operations comprising:
obtaining a sensor output signal describing a speed of a motor of the washing machine, the sensor output signal exhibiting a plurality of pulses, each pulse having a rising edge and a falling edge;
determining a plurality of edge intervals, wherein each edge interval describes an interval of time between edges exhibited by the sensor output signal;
determining a plurality of impulse values, each of the plurality of impulse values being based on three of the plurality of edge intervals, wherein the three edge intervals for each of the plurality of impulse values are respectively separated by an impulse factor; and
determining whether a load of the washing machine appliance is imbalanced based on the plurality of impulse values.

13. The washing machine appliance of claim 12, wherein:
the sensor output signal is output by a Hall effect sensor; and
each edge interval describes an interval of time between consecutive rising edges of the sensor output signal, between consecutive falling edges of the sensor output signal, or between consecutive rising and falling edges of the sensor output signal.

14. The washing machine appliance of claim 12, wherein each of the plurality of impulse values satisfies an equation:
I=|dtₙ−(2*dt_{(n+Dk)})+dt_{(n+2Dk)}|;
wherein I comprises the impulse value;
wherein dt comprises an edge interval;
wherein n is a position of a first value of dt in a sequence and;
wherein Dk comprises the impulse factor.

15. The washing machine appliance of claim 14, wherein the impulse factor is based at least in part on a frequency associated with a speed variation exhibited by a motor speed signal of the washing machine when the load of the washing machine is imbalanced.

16. The washing machine appliance of claim 14, wherein the impulse factor is based at least in part on a moving average of the plurality of edge intervals.

17. The washing machine appliance of claim 12, wherein the impulse factor comprises an integer defining an offset between sequential edge intervals.

18. A washing machine appliance comprising:
a cabinet;
a tub positioned within the cabinet;
a drum rotatably mounted within the tub, the drum defining a wash chamber for receipt of articles for washing;
a motor in mechanical communication with the drum, the motor configured for selectively rotating the drum within the tub;
one or more processors; and
a non-transitory computer readable medium storing instructions that, when executed by the one or more processors, cause the one or more processors to perform operations, the operations comprising:
determining a plurality of edge intervals, wherein each edge interval describes an interval of time between edges exhibited by the sensor output signal, the sensor output signal describing the speed of the motor;
calculating a plurality of impulse values based on the plurality of edge intervals; and
determining whether the drum is imbalanced based at least in part on the plurality of impulse values;
wherein each of the plurality of impulse values comprises the absolute value of a final result of a first edge interval plus a third edge interval minus two times a second edge interval;
wherein, for each of the plurality of impulse values, the second edge interval is temporally separated from the first edge interval by an impulse factor; and
wherein, for each of the plurality of impulse values, the third edge interval is temporally separated from the second edge interval by the impulse factor.

19. The washing machine appliance of claim 18, wherein the impulse factor comprises an integer defining an offset between sequential edge intervals, and wherein the impulse factor is based on a time period of a frequency of a speed modulation exhibited by the motor of the washing machine when the drum of the washing machine is spinning at a speed that will cause a wash load to dehydrate and wherein the wash load being dehydrated is imbalanced because its mass is not evenly distributed about a symmetrical axis of the wash chamber.

20. The washing machine appliance of claim 18, wherein the operations further comprise, prior to calculating the plurality of impulse values based on the plurality of edge intervals, calculating the impulse factor based on one or more of the plurality of edge intervals.
